(19) United States
(12) Patent Application Publication
(10) Pub. No.: US 2003/0084773 A1
(43) Pub. Date: May 8, 2003

(54) Blade fixing device for brushcutter

(76) Inventors: Chang Kyu Joo, Daejeon (KR); Min Seok Joo, Daejeon (KR)

Correspondence Address: STAAS & HALSEY LLP, 700 11TH STREET, NW, SUITE 500, WASHINGTON, DC, 20001, US

(21) Appl. No.: 10/282,008

(22) Filed: Oct. 29, 2002

(30) Foreign Application Priority Data
Nov. 7, 2001 (KR) 2001/34125U

(51) Int. Cl. B26D 1/12

(52) U.S. Cl. 83/666; 83/665

(57) ABSTRACT

In a brushcutter for cutting lawn, grass, weeds and the like, a blade fixing device which can prevent a blade driven by an engine and rotating at a high speed from being severely damaged due to stone or other obstacles and can reduce the load of the engine, by fixedly installing the blade on a drive shaft with a compressive force of a spring. In the brushcutter having an engine mounted on a main body provided with a plurality of wheels mounted thereon, and a clutch and a blade mounted on the drive shaft of the engine, an adaptor is fittingly fixed into the drive shaft rotatably driven by the engine. A holder is disposed on the lower end of the adaptor and is coupled to the adaptor and the drive shaft by means of a fixing bolt. A blade is fitted into the periphery of the holder to be rotatably coupled thereto. Also, a spring is fittingly inserted between the adaptor and the holder and is mounted so as to compressively contact the blade.

### BACKGROUND OF THE INVENTION

1. Field of the Invention

The present invention relates to a brushcutter for cutting lawn, grass, weeds and the like, and more particularly, to a blade fixing device for a brushcutter which can prevent a blade driven by an engine and rotating at a high speed from being severely damaged due to stone or other obstacles and can reduce the load of the engine, by fixedly installing the blade on a drive shaft with a compressive force of a spring.

2. Description of the Related Art

In general, a conventional brushcutter is configured such that a blade is rotated at a high speed by a small engine for trimming the lawn by cutting rank lawn and weeds at a constant height relative to the ground.

In the conventional brushcutter, a small engine is mounted on a main body freely movable by a plurality of wheels mounted thereon, and a blade rotating at a high speed by receiving a driving force from the engine is mounted on the bottom portion inside the main body. In a state in which the engine is driven, the main body is moved to cut the lawn.

Recently, a clutch is mounted between the engine and the drive shaft of the blade to shut or transfer the driving force of the engine transferred to the blade, thereby reducing the drive load of the engine, suppressing unnecessary rotation of the blade and preventing damage of the blade or engine due to stone or other obstacles.

In the conventional brushcutter, in order to prevent damage of an engine and a blade, upon detecting the presence of stone or other obstacles during operation, it is necessary to reduce the number of revolutions of the engine or to make the blade stop rotating by actuating a clutch using a lever. However, since it is quite difficult to detect stone or other obstacles in the ground with rank lawn or weeds, the blade or engine may be quite often damaged due to stone or other obstacles.

Unless the clutch is driven during operation, the blade of the conventional brushcutter keeps rotating by the engine. Thus, the blade or engine may be severely damaged due to stone or other obstacles.

### SUMMARY OF THE INVENTION

To solve the above-described problems, it is an aspect of the present invention to provide a brushcutter in which a blade is fixedly binding on the drive shaft to which the power of an engine is transferred by the compressive force of a spring, rather than directly fixing the blade to the drive shaft. Thus, when an external force stronger than the compressive force is applied to the blade during operation due to stone or other obstacles, the blade is stopped in a state in which the drive shaft keeps rotating, thereby preventing damage to the blade and reducing the load applied to the engine.

### BRIEF DESCRIPTION OF THE DRAWINGS

The above aspect and advantages of the present invention will become more apparent by describing in detail preferred embodiments thereof with reference to the attached drawings in which:

FIG. 1 is a side cross-sectional view showing the installation state according to a first embodiment of the present invention;

FIG. 2 is an exploded perspective view of a blade fixing device according to the present invention;

FIG. 3 is a cross-sectional view showing the connection state of the blade fixing device according to the present invention;

FIG. 4 is a plan view of the blade fixing device according to the present invention;

FIG. 5 is a cross-sectional view of a blade fixing device according to a second embodiment of the present invention;

FIG. 6 is a cross-sectional view of a blade fixing device according to a third embodiment of the present invention;

FIG. 7 is a cross-sectional view of a blade fixing device according to a fourth embodiment of the present invention; and

FIG. 8 is a plan view of the blade fixing device shown in FIG. 7.

### DETAILED DESCRIPTION OF THE INVENTION

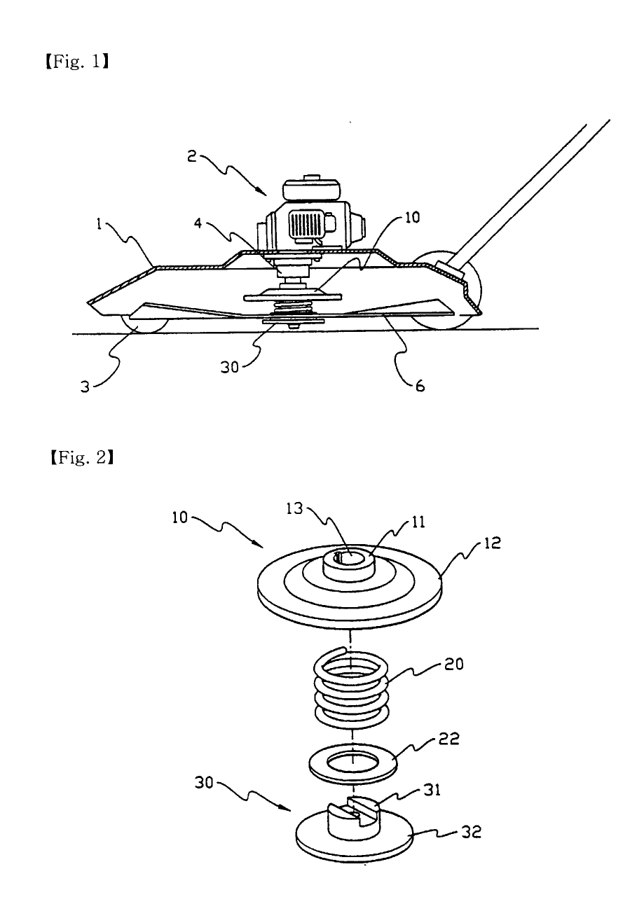

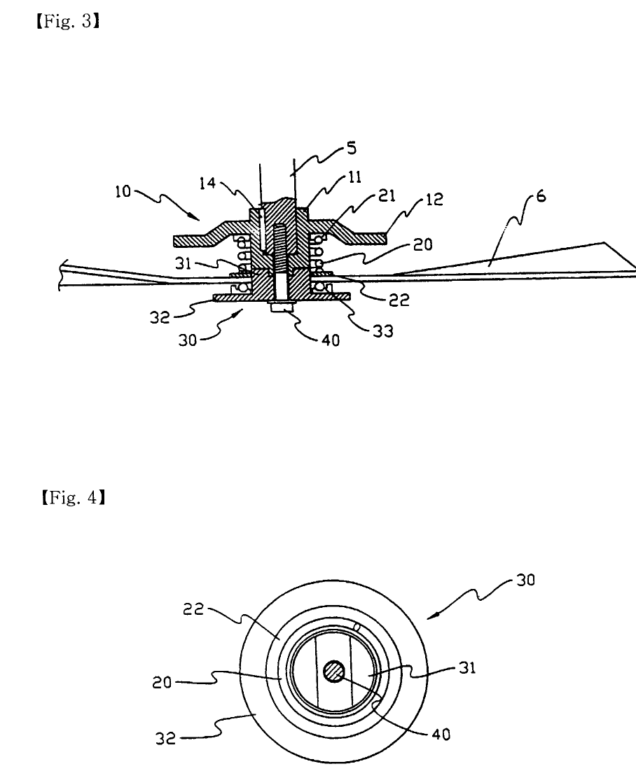

The present invention provides a brushcutter for reducing damage to a blade or engine due to stone or other obstacles by fixedly binding the blade on the drive shaft by the compressive force of a spring. The present invention will be described in detail through several embodiments with reference to FIGS. 1 through 8, in which like reference numerals refer to like parts throughout.

The present invention is directed to a brushcutter having an engine 2 mounted on a main body 1 provided with a plurality of wheels 3 mounted thereon, and a clutch 4 and a blade 6 mounted on the drive shaft 5 of the engine 2, the brushcutter comprising an adaptor 10 fittingly fixed into the drive shaft 5 rotatably driven by the engine 2, a holder 30 disposed on the lower end of the adaptor 10 and coupled to the adaptor 10 and the drive shaft 5 by means of a fixing bolt 40, a blade 6 fitted into the periphery of the holder 30 to be rotatably coupled thereto, and a spring 20 fittingly inserted between the adaptor 10 and the holder 30 and mounted so as to compressively contact the blade 6.

According to the present invention, the blade 6 fitted into and rotatably coupled to the periphery of the holder 30 is compressively fixed by elasticity of the spring 20. If an external force stronger than the compressive force of the spring 20 when the brushcutter strikes stone or other obstacles, the blade 6 is stopped in a state in which the drive shaft 5 rotates, thereby preventing the blade 6 and the engine 2 from being severely damaged.

The adaptor 10 fittingly fixed into the lower end of the drive shaft 5 includes a body 11 provided vertically, a locking groove 13 into which the drive shaft 5 is inserted, and a flange 12 having a diameter greater than the body 11 and provided at the periphery thereof.

Also, the holder 30 fixed on the lower end of the adaptor 10, includes a body 31 having the same diameter as that of the adaptor 10, a flange 32 having a diameter greater than that of the body 31 and provided at the periphery thereof to be fixedly coupled to the adaptor 10 and the drive shaft 5 by means of a fixing bolt 40.

Before the holder 30 is coupled to the adaptor 10 and the drive shaft 5, a spring 20 having a large diameter is fitted into the periphery of the body 31 of the holder 30 and the body 11 of the adaptor 10 and the blade 6 of the brushcutter is placed on the flange 32 of the holder 30. Then, the holder 30 and the adaptor 10 are fixedly coupled to the drive shaft 5 by means of the fixing bolt 40, thereby allowing the spring 20 to press down the blade 6.

Thus, the blade 6 of the brushcutter is placed on the flange 32 in a state in which it is fitted into the periphery of the body 31 of the holder 30 to be applied to the compressive force by elasticity of the spring 20 to be compressively fixed. If the blade 6 is applied to an external force stronger than the compressive force of the spring 20, it stops rotating.

Here, in odder to reduce wearing of the blade 6 and facilitate the rotation thereof, washers 21 and 22 and a bearing 33 for supporting the spring 20 may be installed at the bottom portion of the flange 12 of the adaptor 10, on the flange 32 of the holder 30 and on the blade 6.

However, during operation of the brushcutter, since a large amount of dust and foreign matter is generated, the bearing 33 may be contaminated by dust or foreign matter, resulting in malfunction.

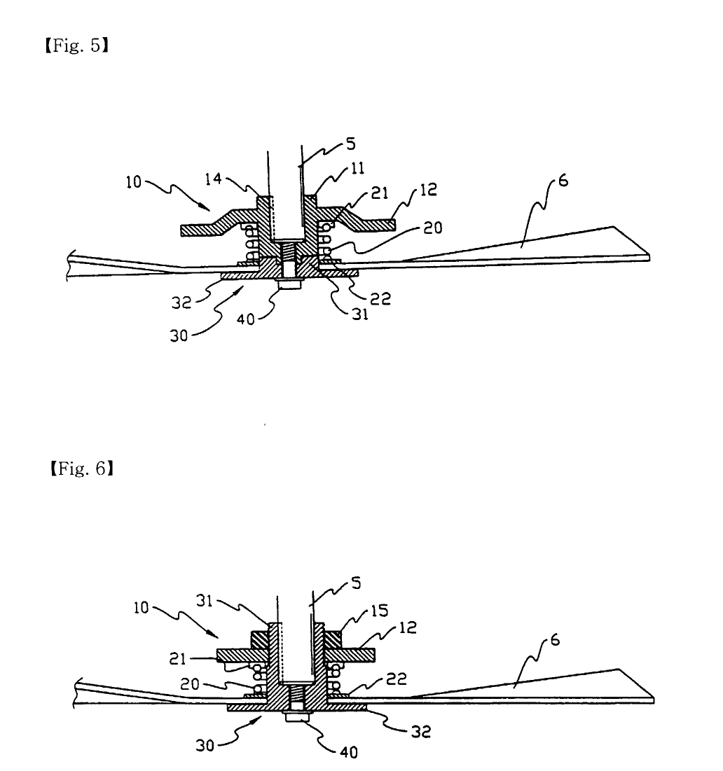

FIG. 5 shows a blade fixing device according to a second embodiment of the present invention. Referring to FIG. 5, a blade 6 may be placed on a flange 32 of a holder 30, without installation of a bearing 33.

In the brushcutter having the above-described configuration, a key 14 is mounted between a drive shaft 5 and an adaptor 10 so that the drive shaft 5 and the adaptor 10 rotate together. Also, the holder 30 coupled to the drive shaft 5 and the adaptor 10 by a fixing bolt 40 rotates by the driving force transferred from an engine 2.

According to the present invention, the blade 6 of the brushcutter is not directly fixed to the drive shaft 5 but is indirectly fixed by the compressive force of a spring 20. Thus, in a state in which the drive shaft 5 and the blade 6 rotate at a high speed by the driving force of the engine 2′, if an external force is applied to the blade 6 due to stone or other obstacles, the blade 6 is stopped in a state in which the drive shaft 5 keeps rotating, thereby preventing excessive damage to the blade 6 and the engine 2.

FIG. 6 is a cross-sectional view of a blade fixing device according to a third embodiment of the present invention, in which a body 31 of a holder 30 extends upward so that a screw is formed on the periphery and a drive shaft 5 is inserted into the body 31 of the holder 30, followed by fixedly coupling the holder 30 to the drive shaft 5 by means of a fixing bolt 40.

Alternatively, the spring 20 for compressively contacting the blade 6 may be inserted into the periphery of the body 31 of the holder 30 to be placed on the blade 6, and the adaptor 10 and a fixing nut 15 are engaged with the screw of the body 31 of the holder 30, thereby allowing the blade 6 to be applied to the compressive force of the spring 20.

In the above-described embodiment, the compressive force of the spring 20 can be adjusted by tightening or untightening the adaptor 10 and the fixing nut 15 engaged with the screw of the body 31 of the holder 30, thereby adjusting a force responsive to the external force applied to the blade 6.

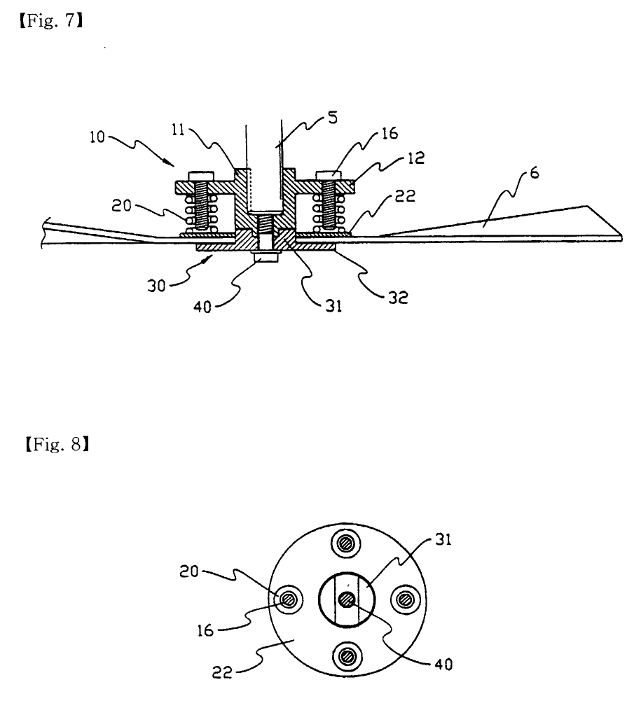

Referring to FIGS. 7 and 8 showing blade fixing devices according to another embodiments of the present invention, in which a plurality of locking members 16 are mounted on the same perimeter of a flange 12 of an adaptor 10. The locking members 16 are spaced apart from each other at a constant angular interval and are vertically engaged to face the holder 30. A spring 20 is fitted on the periphery of each of the locking members 16 so that a blade 6 placed on a flange 32 of the holder 30 is tightly fixed by the compressed force of the spring 20.

According to the above-described embodiment, deviation of the spring 20 can be prevented by fitting the spring 20 on the periphery of the locking member 16. Also, the compressive force applied to the blade 6 can be adjusted by varying the numbers of the locking members 16 and the spring 20 installed.

Therefore, the blade 6 of the brushcutter is not directly fixed to the drive shaft 5 but is indirectly fixed by the compressive force of the spring 20. Thus, in a state in which the drive shaft 5 rotates, the blade 6 is stopped when an external force is applied thereto.

As described above, according to the present invention, since a blade is fixedly installed on a drive shaft of a brushcutter rotatably driven by an engine by the compressive force of a spring, when the brushcutter strikes stone or other obstacles, the blade is stopped in a state in which the drive shaft rotates, thereby preventing the blade and the engine from being severely damaged, and ensuring safety during operation.

While the present invention has been particularly shown and described with reference to preferred embodiments thereof, it will be understood by those of ordinary skill in the art that various changes in form and details maybe made therein without departing from the spirit and scope of the present invention as defined by the following claims.

What is claimed is:

1. A blade fixing device of a brushcutter having an engine mounted on a mounted on a main body provided with a plurality of wheels mounted thereon, and a clutch and a blade mounted on the drive shaft of the engine, the brushcutter comprising:
an adaptor fittingly fixed into the drive shaft rotatably driven by the engine;
a holder disposed on the lower end of the adaptor and coupled to the adaptor and the drive shaft by means of a fixing bolt;
a blade fitted into the periphery of the holder to be rotatably coupled thereto; and
a spring fittingly inserted between the adaptor and the holder and mounted so as to compressively contact the blade.

2. The blade fixing device according to claim 1, wherein the adaptor fittingly fixed into the lower end of the drive shaft includes a body provided vertically, and a flange having a diameter greater than the body and provided at the periphery thereof, and the holder includes a flange having a diameter greater than that of the body and provided at the periphery thereof so that a spring is inserted into the periphery of the body of the holder to press down the blade mounted on the flange of the holder.

3. The blade fixing device according to claim 1, wherein the body of the holder extends upward so that a screw is formed on the periphery and the drive shaft is fixedly coupled to the body of the holder by means of a fixing bolt, and the spring is inserted into the periphery of the body of the holder to be placed on the blade, and the adaptor and a fixing nut are engaged with the screw of the body of the holder, thereby compressively contacting the blade.

4. The blade fixing device according to claim 2, wherein a plurality of locking members are mounted on the same perimeter of the flange of the adaptor, the locking members being spaced apart from each other at a constant angular interval and being vertically engaged to face the holder, and a spring is fitted on the periphery of each of the locking members so that the blade placed on the flange is tightly fixed by the compressed force of the spring.
